(19) United States
(12) Patent Application Publication
(10) Pub. No.: US 2025/0062710 A1
(43) Pub. Date: Feb. 20, 2025

(54) ROTATING ELECTRIC MACHINE CONTROL DEVICE AND ROTATING ELECTRIC MACHINE CONTROL METHOD

(71) Applicant: Mitsubishi Electric Corporation, Tokyo (JP)

(72) Inventors: Masahiro IEZAWA, Tokyo (JP); Jun KITAGAWA, Tokyo (JP); Daiki MATSUURA, Tokyo (JP); Hideaki TANI, Tokyo (JP)

(73) Assignee: Mitsubishi Electric Corporation, Tokyo (JP)

(21) Appl. No.: 18/725,499

(22) PCT Filed: Sep. 28, 2022
(86) PCT No.: PCT/JP2022/036176

§ 371 Date: Jul. 1, 2024

(30) Foreign Application Priority Data
May 12, 2022 (JP) 2022-078587

(51) Int. Cl. H02P 21/22

(52) U.S. Cl. CPC H02P 21/22; H02P 2207/05

(57) ABSTRACT

A control device for a rotating electric machine includes: a reference current command generation unit which generates d-axis and q-axis reference current command values on the basis of a torque command value and a rotation speed; a current phase generation unit which generates a current phase command on the basis of the d-axis and q-axis reference current command values, the torque command value, the rotation speed, and a power supply voltage; a current command generation unit which generates d-axis and q-axis current command values on the basis of the d-axis and q-axis reference current command values and the current phase command; and a voltage command generation unit which generates three-phase voltage command values on the basis of the d-axis and q-axis current command values, the rotation speed, a rotational position, and three-phase currents, and outputs the three-phase voltage command values to an inverter.

### TECHNICAL FIELD

The present disclosure relates to a control device for a rotating electric machine and a control method for a rotating electric machine.

### BACKGROUND ART

A permanent magnet-embedded rotating electric machine with which high efficiency and high output are obtained is sometimes employed as a power source for an automobile, a train, or the like. In the rotating electric machine, a magnet torque due to attraction force and repulsive force that act between coils and permanent magnets, and a reluctance torque due to change in the magnetic resistance at the gap between a stator and a rotor, are obtained.

A control device has been known as a conventional control device for such a permanent magnet-embedded rotating electric machine. This known control device performs vector control by using: efficiency-related best advanced angle Id and Iq maps storing therein a control advanced angle for prioritizing the efficiency of the rotating electric machine; and torque-ripple-minimization-related best advanced angle Id and Iq maps storing therein a control advanced angle for suppressing torque ripple that occurs when the rotating electric machine is driven, in a specific rotational frequency domain. In this control device, vector control is performed with the control advanced angle in the efficiency-related best advanced angle Id and Iq maps on the basis of a torque command value for the rotating electric machine, and, in the specific rotational frequency domain, vector control is performed through switching to the control advanced angle in the torque-ripple-minimization-related best advanced angle Id and Iq maps. In the control device which is thus configured, the output torque of the rotating electric machine can be maximized, and noise, vibrations, and the like due to torque ripple can be inhibited from occurring (see, for example, Patent Document 1).

### CITATION LIST

### Patent Document

Patent Document 1: Japanese Laid-Open Patent Publication No. 2021-150966

### SUMMARY OF THE INVENTION

### Problem to be Solved by the Invention

In the conventional control device, the efficiency-related best advanced angle Id and Iq maps and the torque-ripple-minimization-related best advanced angle Id and Iq maps need to be prestored in a memory or the like. In a case where the rotating electric machine is controlled as a power source for an automobile, a train, or the like, a power supply voltage significantly changes. When the power supply voltage significantly changes, d-axis current and q-axis current with high efficiencies change according to the voltage. Considering the change, a plurality of the efficiency-related best advanced angle Id maps and a plurality of the efficiency-related best advanced angle Iq maps need to be prepared, and a plurality of the torque-ripple-minimization-related best advanced angle Id maps and a plurality of the torque-ripple-minimization-related best advanced angle Iq maps need to be prepared, according to the power supply voltage. Consequently, the conventional control device has a problem that the storage capacity for storing these maps becomes enormous.

The present disclosure has been made to solve the above problem, and an object of the present disclosure is to provide a control device, for a rotating electric machine, that enables decrease in the storage capacity necessary for storing maps for performing vector control.

### Means to Solve the Problem

A control device for a rotating electric machine according to the present disclosure is a control device for a rotating electric machine to be driven with three-phase currents from an inverter, the control device including: a reference current command generation unit which generates a d-axis reference current command value and a q-axis reference current command value on the basis of a torque command value and a rotation speed of the rotating electric machine; a current phase generation unit which generates a current phase command on the basis of the d-axis reference current command value and the q-axis reference current command value which have been generated by the reference current command generation unit, the torque command value, the rotation speed, and a power supply voltage of the rotating electric machine; a current command generation unit which generates a d-axis current command value and a q-axis current command value on the basis of the d-axis reference current command value and the q-axis reference current command value which have been generated by the reference current command generation unit, and the current phase command generated by the current phase generation unit; and a voltage command generation unit which generates three-phase voltage command values on the basis of the d-axis current command value and the q-axis current command value which have been generated by the current command generation unit, the rotation speed, a rotational position of the rotating electric machine, and the three-phase currents, and outputs the three-phase voltage command values to the inverter. The current command generation unit includes: a first magnetic flux calculation unit which calculates a d-axis reference magnetic flux and a q-axis reference magnetic flux from the d-axis reference current command value and the q-axis reference current command value; a reference torque command calculation unit which calculates a reference torque command value on the basis of the d-axis reference magnetic flux and the q-axis reference magnetic flux which have been calculated by the first magnetic flux calculation unit, and the d-axis reference current command value and the q-axis reference current command value; a second magnetic flux calculation unit which calculates a previous d-axis magnetic flux and a previous q-axis magnetic flux from a previous d-axis current command value and a previous q-axis current command value which have been generated by the current command generation unit; and a current command correction calculation unit which calculates the d-axis current command value and the q-axis current command value on the basis of the previous d-axis magnetic flux and the previous q-axis magnetic flux which have been calculated by the second magnetic flux calculation unit, the reference torque command value calculated by the reference torque command calculation unit, and the current phase command.

### Effect of the Invention

In the control device for the rotating electric machine according to the present disclosure, the reference current command generation unit generates a d-axis reference current command value and a q-axis reference current command value by using Id and Iq reference current command maps, the current phase generation unit generates a current phase command on the basis of the d-axis reference current command value, the q-axis reference current command value, the rotation speed, and the power supply voltage of the rotating electric machine, and, in the current command generation unit, a reference torque command value is generated on the basis of the d-axis reference magnetic flux, the q-axis reference magnetic flux, the d-axis reference current command value, and the q-axis reference current command value, and a d-axis current command value and a q-axis current command value are calculated on the basis of the previous d-axis magnetic flux, the previous q-axis magnetic flux, the reference torque command value, and the current phase command. Consequently, the storage capacity necessary for storing maps for performing vector control can be decreased.

### BRIEF DESCRIPTION OF THE DRAWINGS

FIG. 1 is a configuration diagram of a control device for a rotating electric machine according to embodiment 1.

FIG. 2 is a cross-sectional view of the rotating electric machine according to embodiment 1.

FIG. 3 is a diagram for explaining Id and Iq reference current command maps according to embodiment 1.

FIG. 4 is a configuration diagram of a current command generation unit according to embodiment 1.

FIG. 5 shows a hardware configuration for realizing the control device for the rotating electric machine according to embodiment 1.

### DESCRIPTION OF EMBODIMENTS

Hereinafter, a control device for a rotating electric machine according to an embodiment for carrying out the present disclosure will be described in detail with reference to the drawings. The same or corresponding constituents in the drawings are denoted by the same reference characters.

### Embodiment 1

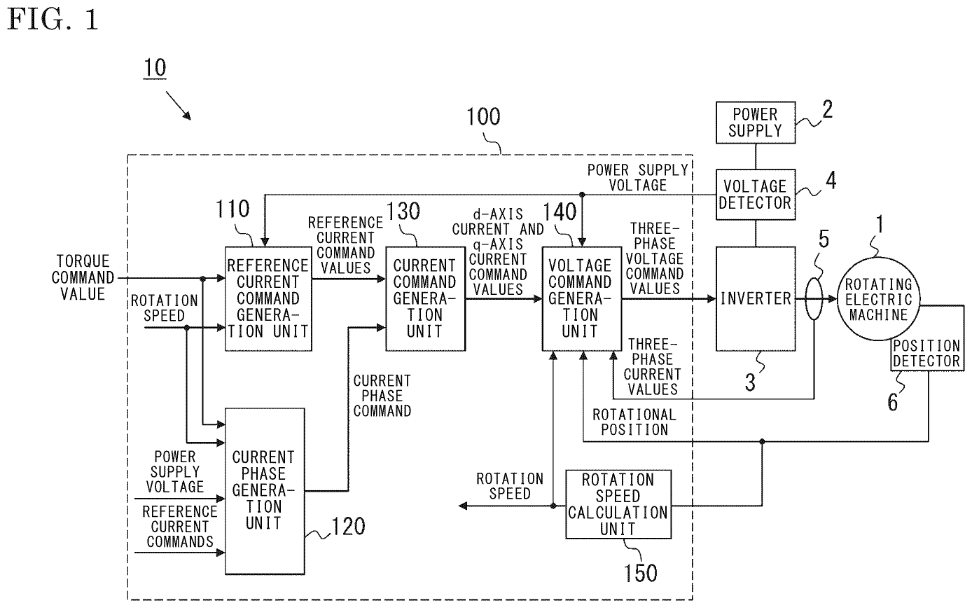

FIG. 1 is a configuration diagram of a control device for a rotating electric machine according to embodiment 1. FIG. 1 shows the entirety of a rotating electric machine control system including the control device for the rotating electric machine according to the present embodiment. The rotating electric machine control system 10 is composed of a rotating electric machine 1, a power supply 2, an inverter 3, a voltage detector 4, a current detector 5, a position detector 6, and a control device 100.

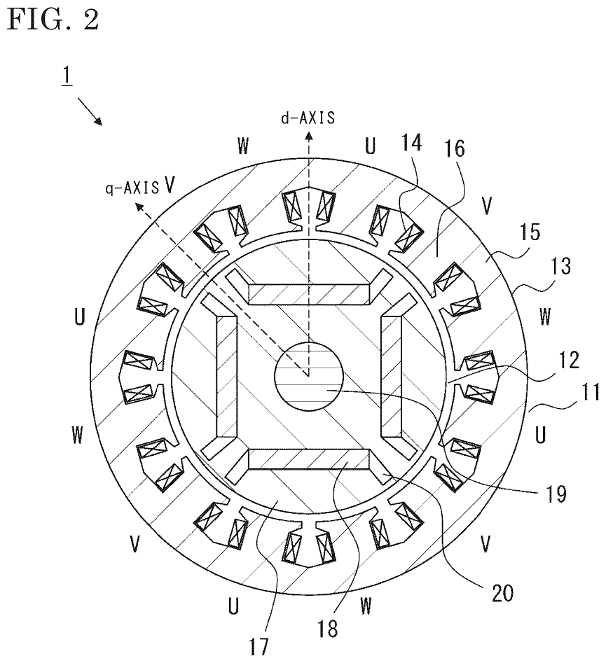

FIG. 2 is a cross-sectional view of the rotating electric machine 1 to be driven by the control device 100 according to the present embodiment. The rotating electric machine 1 is a 4-pole 12-slot magnet-embedded rotating electric machine. As shown in FIG. 2, the rotating electric machine 1 has an annular stator 11 and a columnar rotor 12 rotatably supported by the stator 11. The stator 11 includes an annular stator core 13 and coils 14. The stator core 13 includes an annular core back 15 and a plurality of teeth 16 protruding radially inward from the core back 15. The intervals between the plurality of teeth 16 serve as slots, and, by utilizing these slots, the coils 14 are wound around the teeth 16 through concentrated winding. The coils 14 are composed of coils for three phases which are a U phase, a V phase, and a W phase.

The rotor 12 includes a columnar rotor core 17, permanent magnets 18, and a rotation shaft 19 fastened to the center of the rotor core 17. The rotor core 17 has magnet insertion holes 20 formed so as to be arrayed in the circumferential direction. The permanent magnets 18 are fixed into the magnet insertion holes 20. The rotating electric machine 1 to be controlled by the control device 100 according to the present embodiment is not limited to the 4-pole 12-slot magnet-embedded rotating electric machine shown in FIG. 2 as long as the rotating electric machine is driven with three-phase currents.

In the rotating electric machine 1 shown in FIG. 2, the direction of a magnetic flux generated by each of the permanent magnets 18 of the rotor 12 is a d-axis, and a direction electrically orthogonal to the d-axis is a q-axis. The control device 100 for the rotating electric machine according to the present embodiment controls the rotating electric machine 1 through vector control. In the vector control, excitation current (d-axis current) for controlling the intensities of fields and torque current (q-axis current) for generating torque are controlled with a two-dimensional orthogonal vector coordinate system having the d-axis and the q-axis. In the vector control, coordinate transformation based on the rotational position (rotation angle) of the rotor of the rotating electric machine 1 is introduced, and thus currents Iu, Iv, and Iw for the three phases flowing to the rotating electric machine 1 are converted into a d-axis current (hereinafter, also written as Id) and a q-axis current (hereinafter, also written as Iq) orthogonal to the d-axis current, and components are independently controlled as in a DC motor.

The power supply 2 is a DC power supply for outputting DC voltage. As the power supply 2, for example, a lithium-ion battery or the like may be used. The inverter 3 is a three-phase inverter including a plurality of switching elements and diodes reversely connected to the switching elements. The inverter 3 converts, on the basis of three-phase voltage command values from the control device 100, the DC voltage inputted from the power supply 2 into three-phase AC voltage and drives the rotating electric machine 1 with the outputs for the three phases which are the U phase, the V phase, and the W phase.

The voltage detector 4 detects the output voltage of the power supply 2. The voltage detector 4 detects, with a voltage detection circuit composed of an operational amplifier and the like, a voltage resulting from dividing the power supply voltage by a resistance, for example. Information about the power supply voltage detected by the voltage detector 4 is inputted to the control device 100.

The current detector 5 detects a current flowing to the rotating electric machine 1. Specifically, the current detector 5 is composed of a U-phase current sensor, a V-phase current sensor, and a W-phase current sensor that respectively detect a U-phase current Iu, a V-phase current Iv, and a W-phase current Iw. Alternatively, since the sum of the instantaneous values of the currents Iu, Iv, and Iw for the respective phases is 0, the current detector 5 may detect the currents for two of the phases (for example, the V-phase current Iv and the W-phase current Iw) and calculate the current for the remaining one phase (for example, the U-phase current Iu). Pieces of current information about the currents Iu, Iv, and Iw for the respective phases detected by the current detector 5 are inputted to the control device 100.

The position detector 6 detects a rotation angle θ of (rotational position information about) the rotation shaft of the rotating electric machine 1. As the position detector 6, for example, a resolver that can detect, with a high resolution, the rotation angle θ through magnetic coupling to the rotation shaft of the rotating electric machine 1, a magnetic encoder, an optical encoder, or the like is used. The detected rotational position information is inputted to the control device 100.

The control device 100 outputs, to the inverter 3, commands regarding an amplitude and a frequency of a current to be superimposed for the rotating electric machine 1, on the basis of the information about the power supply voltage, the current information, and the rotational position information respectively inputted from the voltage detector 4, the current detector 5, and the position detector 6, and a torque command value inputted from an external device. The control device 100 is implemented by a digital calculation device such as a microcomputer or a field-programmable gate array (FPGA) and has a function of repeating data input, calculation, and data output at any time interval (a fixed time interval or a variable time interval).

As shown in FIG. 1, the control device 100 according to the present embodiment includes a reference current command generation unit 110, a current phase generation unit 120, a current command generation unit 130, a voltage command generation unit 140, and a rotation speed calculation unit 150.

The reference current command generation unit 110 receives a torque command value from a higher-order external device. In addition, the reference current command generation unit 110 receives a rotation speed of the rotating electric machine 1 from the rotation speed calculation unit 150 described later. In a case where, for example, the rotating electric machine 1 is used as a power source for an automobile, the higher-order external device is an electronic control unit (ECU) of a control system for the automobile, or the like. Furthermore, the reference current command generation unit 110 receives a power supply voltage from the voltage detector 4. The reference current command generation unit 110 outputs Id and Iq reference current command values on the basis of the received torque command value and rotation speed.

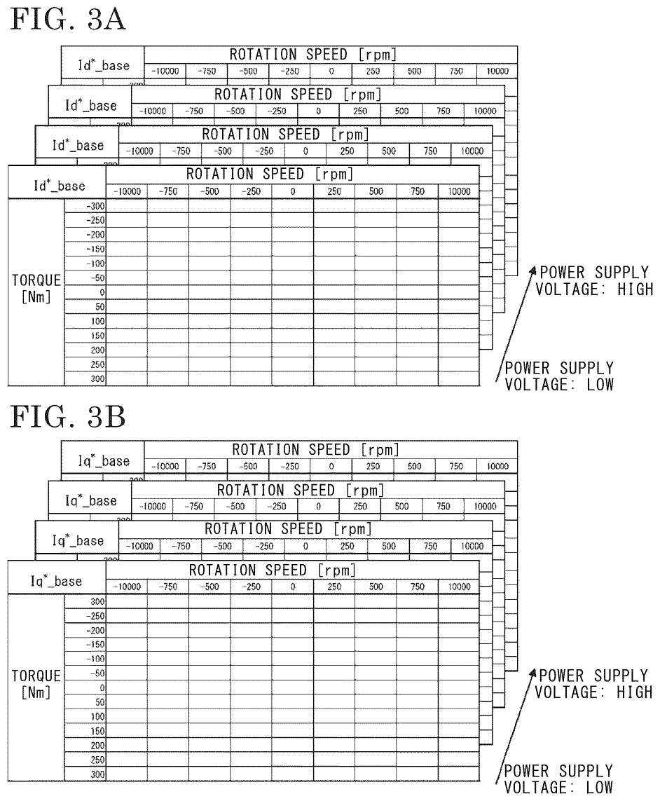

FIG. 3 is a diagram for explaining Id and Iq reference current command maps used in the reference current command generation unit 110. FIG. 3(a) shows an Id reference current command map, and FIG. 3(b) shows an Iq reference current command map. As shown in FIG. 3, each of the reference current command maps is a two-dimensional map having the torque command value and the rotation speed as respective axes. In the reference current command map, reference current command values are predetermined according to torque command values and rotation speeds. Furthermore, each of the reference current command maps is composed of a plurality of maps that are set for respective voltage values of the power supply voltage. For example, in the reference current command map, maps are set for respective power supply voltages which differ from each other by 5 V. In the control device 100 according to the present embodiment, the reference current command maps are created with a combination, of Id and Iq, at which the total of power loss in the rotating electric machine 1 and power loss in the inverter 3 is minimum. The reference current command maps are stored in a storage unit inside or outside of the reference current command generation unit 110. The reference current command generation unit 110 outputs Id and Iq reference current command values on the basis of the power supply voltage, the torque command value, and the rotation speed by using the Id and Iq reference current command maps. Hereinafter, the d-axis reference current command value and the q-axis reference current command value which have been outputted by the reference current command generation unit 110 are respectively denoted by Id*_base and Iq*_base.

The current phase generation unit 120 receives the torque command value from the higher-order external device and receives the rotation speed of the rotating electric machine 1 from the rotation speed calculation unit 150. In addition, the current phase generation unit 120 receives the power supply voltage from the voltage detector 4 and receives the reference current command values from the reference current command generation unit 110. The current phase generation unit 120 outputs a current phase command on the basis of the received data. Hereinafter, the current phase command outputted by the current phase generation unit 120 is written as β.

Examples of a method for determining β include: a method in which a function is used; a method in which a map is used; and the like. Examples of the method in which a function is used include a method in which β is calculated by using a function that has the received rotation speed as a parameter. Examples of the method in which a map is used include a method in which β is determined by using a two-dimensional map having the received rotation speed and power supply voltage as respective axes. In such a method in which a function is used or such a method in which a map is used, a function or a map may be set so as to decrease at least one of power loss, torque pulsation, noise, and heat generation in a specific region or a plurality of regions with respect to the rotational frequency of the rotating electric machine 1. The function or the map is stored in a storage unit inside or outside of the current phase generation unit 120.

As a function for use in the method for determining β, the following function may be set. That is, the set function may be for calculating a current phase command β by using a current phase β₀ and the rotation speed as parameters, where the current phase β₀ is based on the received reference current command values and has been calculated from the reference current command values by using the following expression (1).

$$[ Mathematical 1 ]$$

$${β}_{0} = {tan}^{- 1} ( - {I}_{d \_ base}^{*} / {I}_{q \_ base}^{*} ) \qquad ( 1 )$$

The current phase generation unit 120 may have a plurality of the functions or maps. In this case, the current phase generation unit 120 may select an optimum function or map for calculating a current phase command β from among the plurality of the functions or maps according to a mode identification signal that is inputted from the higher-order external device and that is for identifying, for example, an efficiency maximizing mode, a torque ripple decreasing mode, a noise decreasing mode, a heat generation decreasing mode, or the like.

The current command generation unit 130 outputs current command values for causing the voltage command generation unit 140 to perform current control (vector control). The current command generation unit 130 receives the reference current command values Id*_base and Iq*_base from the reference current command generation unit 110 and receives the current phase command β from the current phase generation unit 120. The current command generation unit 130 outputs a d-axis current command value and a q-axis current command value to the voltage command generation unit 140 on the basis of the received reference current command values and the received current phase command. Hereinafter, the d-axis current command value is denoted by Id*, and the q-axis current command value is denoted by Iq*.

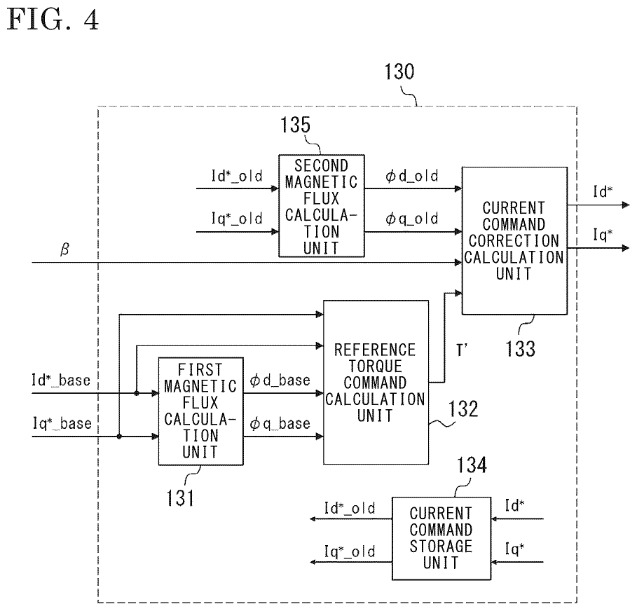

FIG. 4 is a configuration diagram of the current command generation unit according to the present embodiment 1. As shown in FIG. 4, the current command generation unit 130 according to the present embodiment includes a first magnetic flux calculation unit 131, a reference torque command calculation unit 132, a current command correction calculation unit 133, a current command storage unit 134, and a second magnetic flux calculation unit 135.

The first magnetic flux calculation unit 131 receives the d-axis reference current command value Id*_base and the q-axis reference current command value Iq*_base from the reference current command generation unit 110. The first magnetic flux calculation unit 131 calculates a d-axis reference magnetic flux ϕd_base and a q-axis reference magnetic flux ϕq base on the basis of the received reference current command values and outputs the results of the calculation to the reference torque command calculation unit 132. The first magnetic flux calculation unit 131 can calculate the reference magnetic fluxes from the reference current command values by applying, for example, a magnetic flux map for use in decoupling compensation calculation of current control calculation (vector control calculation) by the voltage command generation unit 140. Since a magnetic flux is obtained by multiplying an inductance by a current command value, the first magnetic flux calculation unit 131 may use an inductance map instead of the magnetic flux map.

The second magnetic flux calculation unit 135 receives previous current command values Id*_old and Iq*_old from the current command storage unit 134 described later. The second magnetic flux calculation unit 135 calculates a previous d-axis magnetic flux od old and a previous q-axis magnetic flux ϕq_old on the basis of the received previous current command values and outputs the results of the calculation to the current command correction calculation unit 133. In the same manner as the first magnetic flux calculation unit 131, the second magnetic flux calculation unit 135 can calculate the reference magnetic fluxes from the reference current command values by applying the magnetic flux map for use in decoupling compensation calculation of current control calculation by the voltage command generation unit 140.

The first magnetic flux calculation unit 131 and the second magnetic flux calculation unit 135 can apply, at the time of calculating magnetic fluxes from the received current command values, the magnetic flux map for use in decoupling compensation calculation of current control calculation by the voltage command generation unit 140. Consequently, storage capacities for magnetic flux maps can be inhibited from being added.

The reference torque command calculation unit 132 receives the d-axis reference current command value Id*_base and the q-axis reference current command value Iq*_base from the reference current command generation unit 110 and receives the d-axis reference magnetic flux ϕd_base and the q-axis reference magnetic flux ϕq_base from the first magnetic flux calculation unit 131. The reference torque command calculation unit 132 calculates a reference torque command value T′ from the reference current command values and the reference magnetic fluxes by using the following expression (2). The reference torque command value calculated according to expression (2) is a reference torque command value T′ reflecting compensation for torque loss due to mechanical loss and iron loss in the rotating electric machine 1. The reference torque command calculation unit 132 outputs the calculated reference torque command value T′ to the current command correction calculation unit 133.

$$[ Mathematical 2 ]$$

$${T}^{′} = p \times ( {∅}_{d \_ base} \times {I}_{q \_ base}^{*} - {∅}_{q \_ base} \times {I}_{d \_ base}^{*} ) \qquad ( 2 )$$

Here, p represents the number of pole pairs in the rotating electric machine 1. In the rotating electric machine 1 shown in FIG. 2, p equals 4.

The current command correction calculation unit 133 receives the current phase command β from the current phase generation unit 120, receives the reference torque command value T′ from the reference torque command calculation unit 132, and receives the previous d-axis magnetic flux ϕd_old and the previous q-axis magnetic flux ϕq_old from the second magnetic flux calculation unit 135. The current command correction calculation unit 133 calculates Id* and Ig* by using the following expression (3), expression (4), and expression (5).

$$[ Mathematical 3 ]$$

$${I}_{a} = \frac{{T}^{′}}{p \times ( {∅}_{d \_ old} \times cos β + {∅}_{q \_ old} \times sin β )} \qquad ( 3 )$$

$$[ Mathematical 4 ]$$

$${I}_{d}^{*} = - {I}_{a} \times sin β \qquad ( 4 )$$

$$[ Mathematical 5 ]$$

$${I}_{q}^{*} = {I}_{a} \times cos β \qquad ( 5 )$$

Here, Iₐ represents a current amplitude.

The current command storage unit 134 stores therein Id* and Iq* outputted from the current command correction calculation unit 133. In addition, the current command storage unit 134 outputs, to the second magnetic flux calculation unit 135, already-stored Id* and Iq* as previous current command values Id*_old and Iq*_old.

As indicated in expression (3), the current amplitude can be obtained from information about the torque, information about the current phase, and information about the magnetic fluxes. However, regarding magnetic fluxes in the rotating electric machine, a problem arises in that the rotor core and the stator core have magnetic saturation characteristics, and thus the magnetic fluxes cannot be calculated without determining a d-axis current and a q-axis current. As a result, a problem arises in that neither Id* nor Iq* can be calculated. Meanwhile, in the control device according to the present embodiment, the second magnetic flux calculation unit 135 calculates the previous d-axis magnetic flux ϕd_old and the previous q-axis magnetic flux ϕq_old from the previous d-axis current and the previous q-axis current. Then, as indicated in expression (3), the current amplitude is calculated by using the previous d-axis magnetic flux ϕd_old and the previous q-axis magnetic flux ϕq_old, whereby Id* and Iq* can be calculated.

Expressions (2) to (5) are expressions obtained from the relationship among torque, magnetic flux, current, and current phase. Such expressions indicating the relationship among torque, magnetic flux, current, and current phase can be variously expressed through transformation. Therefore, the expressions used in the current command correction calculation unit 133 may be expressed in other styles as long as the same results are obtained.

The voltage command generation unit 140 receives the d-axis current command value Id* and the q-axis current command value Iq* from the current command generation unit 130. The voltage command generation unit 140 performs vector control calculation on the basis of Id* and Iq* and outputs three-phase voltage command values Vu*, Vv*, and Vw* to the inverter 3.

The voltage command generation unit 140 includes, for example, a calculation unit composed of proportional-integral-differential (PID) controller elements, a current coordinate transformation unit, and a voltage coordinate transformation unit. The current coordinate transformation unit performs, by using information about the rotation angle θ of the rotor of the rotating electric machine 1 detected by the position detector 6, coordinate transformation on the three-phase currents (Iu, Iv, and Iw) detected by the current detector 5 into a two-dimensional orthogonal vector coordinate system having a d-axis and a q-axis. Consequently, the current coordinate transformation unit calculates an actual d-axis current Id and an actual q-axis current Iq. The calculation unit calculates a d-axis voltage command value Vd and a q-axis voltage command value Vq by using the actual d-axis current Id and the actual q-axis current Iq which have been calculated by the current coordinate transformation unit. The voltage coordinate transformation unit transforms, by using the information about the rotation angle θ of the rotor of the rotating electric machine 1 detected by the position detector 6 and Id* and Iq*, the d-axis voltage command value Vd and the q-axis voltage command value Vq which have been calculated by the calculation unit into the three-phase voltage command values (Vu, Vv, and Vw).

The rotation speed calculation unit 150 calculates a rotation speed of the rotor of the rotating electric machine 1 on the basis of the rotational position information from the position detector 6. The rotation speed calculation unit 150 calculates the rotation speed by, for example, calculating the difference between pieces of the rotational position information that have been detected at different times T1 and T2 by the position detector 6 and dividing this difference by the time difference between T2 and T1. The rotation speed calculation unit 150 outputs the calculated rotation speed to the reference current command generation unit 110, the current phase generation unit 120, and the voltage command generation unit 140.

As shown in FIG. 1, the control device for the rotating electric machine according to the present embodiment includes: a reference current command generation unit which generates a d-axis reference current command value and a q-axis reference current command value on the basis of a torque command value and a rotation speed of the rotating electric machine; a current phase generation unit which generates a current phase command on the basis of the d-axis reference current command value and the q-axis reference current command value, the torque command value, the rotation speed, and a power supply voltage of the rotating electric machine; a current command generation unit which generates a d-axis current command value and a q-axis current command value on the basis of the d-axis reference current command value and the q-axis reference current command value, and the current phase command generated by the current phase generation unit; and a voltage command generation unit which generates three-phase voltage command values on the basis of the d-axis current command value and the q-axis current command value, the rotation speed, a rotational position of the rotating electric machine, and three-phase currents, and outputs the three-phase voltage command values to an inverter.

As shown in FIG. 4, the current command generation unit includes: a first magnetic flux calculation unit which calculates a d-axis reference magnetic flux and a q-axis reference magnetic flux from the d-axis reference current command value and the q-axis reference current command value; a reference torque command calculation unit which calculates a reference torque command value on the basis of the d-axis reference magnetic flux and the q-axis reference magnetic flux, and the d-axis reference current command value and the q-axis reference current command value; a second magnetic flux calculation unit which calculates a previous d-axis magnetic flux and a previous q-axis magnetic flux from a previous d-axis current command value and a previous q-axis current command value which have been generated by the current command generation unit; and a current command correction calculation unit which calculates the d-axis current command value and the q-axis current command value on the basis of the previous d-axis magnetic flux and the previous q-axis magnetic flux, the reference torque command value, and the current phase command.

In the control device for the rotating electric machine according to the present embodiment, the reference current command generation unit generates a d-axis reference current command value and a q-axis reference current command value by using the Id and Iq reference current command maps. In addition, the current phase generation unit generates a current phase command on the basis of the d-axis reference current command value, the q-axis reference current command value, the torque command value, the rotation speed, and the power supply voltage of the rotating electric machine. Furthermore, in the current command generation unit, a reference torque command value is generated on the basis of the d-axis reference magnetic flux, the q-axis reference magnetic flux, the d-axis reference current command value, and the q-axis reference current command value, and a d-axis current command value and a q-axis current command value are calculated on the basis of the previous d-axis magnetic flux, the previous q-axis magnetic flux, the reference torque command value, and the current phase command.

In the control device, for the rotating electric machine, which is thus configured, previous magnetic fluxes are calculated by using the previous current command values, and amplitudes of current command values are calculated by using the previous magnetic fluxes, the current phase command, and the reference torque command. Consequently, it is unnecessary to prepare different maps for the case of prioritizing efficiency and the case of prioritizing torque ripple minimization. Thus, only one Id reference current command map and one Iq reference current command map have to be prepared according to the power supply voltage. Therefore, the storage capacity necessary for storing maps for performing vector control can be decreased. For example, in a conventional control device for a rotating electric machine, two types of maps which are a map in the case of prioritizing efficiency and a map in the case of prioritizing torque ripple minimization need to be prepared for each of Id and Iq. That is, a total of four types of maps need to be prepared. Furthermore, a plurality of maps corresponding to respective power supply voltages are necessary for each type of map. Meanwhile, in the control device for the rotating electric machine according to the present embodiment, expressions (2) to (5) are used. Consequently, only one type of map has to be prepared for each of Id and Iq. That is, only two types of maps have to be prepared instead of the above four types of maps. In addition, a plurality of maps corresponding to the respective power supply voltages are necessary for each type of map. These are the only maps that are necessary. As a result, in the control device for the rotating electric machine according to the present embodiment, the number of maps can be set to half the number of maps in the conventional control device.

In the calculation based on expressions (2) to (5), present current command values are calculated by using previous current command values on the assumption that the current commands continuously change. Consequently, when the reference torque command value T′ or the current phase command β discontinuously changes, Id* and Iq* might discontinuously change. In order to prevent this discontinuous change, a map or a function may be preset such that the torque command value, the reference current command values, and the current phase command become smooth so as not to discontinuously change. Alternatively, the current command correction calculation unit 133 may perform filter processing, change rate limitation processing, or the like on Id* and Iq* which have been calculated by using expressions (3) to (5), such that Id* and Iq* are inhibited from discontinuously changing.

In addition, in the control device for the rotating electric machine according to the present embodiment, the current phase generation unit 120 may have a plurality of the functions or maps. Consequently, an optimum function or map can be selected from among the plurality of the functions or maps according to a mode identification signal that is inputted from the higher-order external device and that is for identifying the efficiency maximizing mode, the torque ripple decreasing mode, the noise decreasing mode, the heat generation decreasing mode, or the like. Therefore, the control device also has an advantageous effect of eliminating the necessity of design change, of hardware of the control device, that is conventionally necessary in order to adapt to each of the modes.

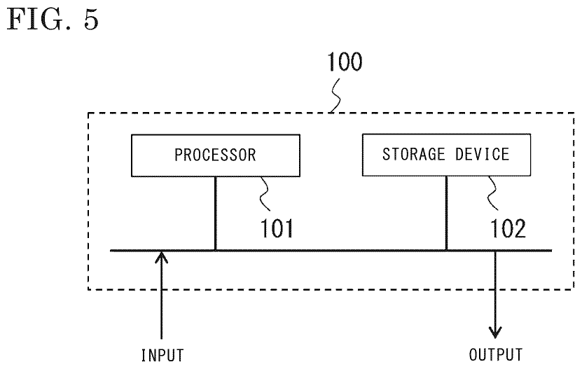

An example of the hardware of the control device 100 is shown in FIG. 5. The hardware is composed of a processor 101 and a storage device 102. Although not shown, the storage device 102 includes a volatile storage device such as a random access memory and a nonvolatile auxiliary storage device such as a flash memory. Alternatively, the storage device may include, as the auxiliary storage device, a hard disk instead of a flash memory. The processor 101 executes a program inputted from the storage device 102. In this case, the program is inputted from the auxiliary storage device via the volatile storage device to the processor 101. Furthermore, the processor 101 may output data such as a calculation result to the volatile storage device of the storage device 102 or may save the data via the volatile storage device into the auxiliary storage device.

Although the disclosure is described above in terms of an exemplary embodiment, it should be understood that the various features, aspects, and functionality described in the embodiment are not limited in their applicability to the particular embodiment with which they are described, but instead can be applied alone or in various combinations to the embodiment of the disclosure.

It is therefore understood that numerous modifications which have not been exemplified can be devised without departing from the scope of the specification of the present disclosure. For example, at least one of the constituent components may be modified, added, or eliminated.

### DESCRIPTION OF THE REFERENCE CHARACTERS

1 rotating electric machine
2 power supply
3 inverter
4 voltage detector
5 current detector
6 position detector
10 rotating electric machine control system
11 stator
12 rotor
13 stator core
14 coil
15 core back
16 tooth
17 rotor core
18 permanent magnet
19 rotation shaft
20 magnet insertion hole
100 control device
101 processor
102 storage device
110 reference current command generation unit
120 current phase generation unit
130 current command generation unit
131 first magnetic flux calculation unit
132 reference torque command calculation unit
133 current command correction calculation unit
134 current command storage unit
135 second magnetic flux calculation unit
140 voltage command generation unit
150 rotation speed calculation unit

1. A control device for a rotating electric machine to be driven with three-phase currents from an inverter, the control device comprising:
a reference current command generation circuitry which generates a d-axis reference current command value and a q-axis reference current command value on the basis of a torque command value and a rotation speed of the rotating electric machine;
a current phase generation circuitry which generates a current phase command on the basis of the d-axis reference current command value and the q-axis reference current command value which have been generated by the reference current command generation unit, the torque command value, the rotation speed, and a power supply voltage of the rotating electric machine;
a current command generation circuitry which generates a d-axis current command value and a q-axis current command value on the basis of the d-axis reference current command value and the q-axis reference current command value which have been generated by the reference current command generation circuitry, and the current phase command generated by the current phase generation circuitry; and
a voltage command generation circuitry which generates three-phase voltage command values on the basis of the d-axis current command value and the q-axis current command value which have been generated by the current command generation circuitry, the rotation speed, a rotational position of the rotating electric machine, and the three-phase currents, and outputs the three-phase voltage command values to the inverter, wherein
the current command generation circuitry includes
a first magnetic flux calculation circuitry which calculates a d-axis reference magnetic flux and a q-axis reference magnetic flux from the d-axis reference current command value and the q-axis reference current command value,
a reference torque command calculation circuitry which calculates a reference torque command value on the basis of the d-axis reference magnetic flux and the q-axis reference magnetic flux which have been calculated by the first magnetic flux calculation circuitry, and the d-axis reference current command value and the q-axis reference current command value,
a second magnetic flux calculation circuitry which calculates a previous d-axis magnetic flux and a previous q-axis magnetic flux from a previous d-axis current command value and a previous q-axis current command value which have been generated by the current command generation circuitry, and
a current command correction calculation circuitry which calculates the d-axis current command value and the q-axis current command value on the basis of the previous d-axis magnetic flux and the previous q-axis magnetic flux which have been calculated by the second magnetic flux calculation circuitry, the reference torque command value calculated by the reference torque command calculation circuitry, and the current phase command.

2. The control device for the rotating electric machine according to claim 1, wherein the current phase generation circuitry calculates the current phase command by using a function having, as parameters, the d-axis reference current command value, the q-axis reference current command value, the rotation speed, and the power supply voltage of the rotating electric machine.

3. The control device for the rotating electric machine according to claim 2, wherein the current phase generation circuitry includes a plurality of the functions and selects one of the plurality of the functions according to an inputted mode identification signal.

4. The control device for the rotating electric machine according to claim 1, wherein the current command correction calculation circuitry performs filter processing or change rate limitation processing on the d-axis current command value and the q-axis current command value which have been calculated.

5. A control method for a rotating electric machine to be driven with three-phase currents from an inverter, the control method comprising:
a reference current command generation step of generating a d-axis reference current command value and a q-axis reference current command value on the basis of a torque command value and a rotation speed of the rotating electric machine;
a current phase generation step of generating a current phase command on the basis of the d-axis reference current command value and the q-axis reference current command value which have been generated in the reference current command generation step, the torque command value, the rotation speed, and a power supply voltage of the rotating electric machine;
a current command generation step of generating a d-axis current command value and a q-axis current command value on the basis of the d-axis reference current command value and the q-axis reference current command value which have been generated in the reference current command generation step, and the current phase command generated in the current phase generation step; and
a voltage command generation step of generating three-phase voltage command values on the basis of the d-axis current command value and the q-axis current command value which have been generated in the current command generation step, the rotation speed, a rotational position of the rotating electric machine, and the three-phase currents, and outputting the three-phase voltage command values to the inverter, wherein
the current command generation step includes
a first magnetic flux calculation step of calculating a d-axis reference magnetic flux and a q-axis reference magnetic flux from the d-axis reference current command value and the q-axis reference current command value,
a reference torque command calculation step of calculating a reference torque command value on the basis of the d-axis reference magnetic flux and the q-axis reference magnetic flux which have been calculated in the first magnetic flux calculation step, and the d-axis reference current command value and the q-axis reference current command value,
a second magnetic flux calculation step of calculating a previous d-axis magnetic flux and a previous q-axis magnetic flux from a previous d-axis current command value and a previous q-axis current command value which have been generated in the current command generation step, and
a current command correction calculation step of calculating the d-axis current command value and the q-axis current command value on the basis of the previous d-axis magnetic flux and the previous q-axis magnetic flux which have been calculated in the second magnetic flux calculation step, the reference torque command value calculated in the reference torque command calculation step, and the current phase command.

6. The control method for the rotating electric machine according to claim 5, wherein the current phase generation step includes calculating the current phase command by using a function having, as parameters, the d-axis reference current command value, the q-axis reference current command value, the rotation speed, and the power supply voltage of the rotating electric machine.

7. The control method for the rotating electric machine according to claim 6, wherein, with a plurality of the functions being present, the current phase generation step includes selecting one of the plurality of the functions according to an inputted mode identification signal.

8. The control method for the rotating electric machine according to claim 5, wherein the current command correction calculation step includes performing filter processing or change rate limitation processing on the d-axis current command value and the q-axis current command value which have been calculated.

9. The control device for the rotating electric machine according to claim 2, wherein the current command correction calculation circuitry performs filter processing or change rate limitation processing on the d-axis current command value and the q-axis current command value which have been calculated.

10. The control device for the rotating electric machine according to claim 3, wherein the current command correction calculation circuitry performs filter processing or change rate limitation processing on the d-axis current command value and the q-axis current command value which have been calculated.

11. The control method for the rotating electric machine according to claim 6, wherein the current command correction calculation step includes performing filter processing or change rate limitation processing on the d-axis current command value and the q-axis current command value which have been calculated.

12. The control method for the rotating electric machine according to claim 7, wherein the current command correction calculation step includes performing filter processing or change rate limitation processing on the d-axis current command value and the q-axis current command value which have been calculated.
